(19) United States
(12) Patent Application Publication
(10) Pub. No.: US 2022/0391385 A1
(43) Pub. Date: Dec. 8, 2022

(54) System and Method of Managing Report

(71) Applicants: Inventec (Pudong) Technology Corp., Shanghai (CN); Inventec Corporation, Taipei (TW)

(72) Inventors: Chih-Chin Yu, Taipei (TW); Yung-Wei Tseng, Taipei (TW); Yu-Fu Chen, Taipei (TW); Wan-Ling Zhong, Taipei (TW)

(73) Assignees: Inventec (Pudong) Technology Corp., Shanghai (CN); Inventec Corporation, Taipei (TW)

(21) Appl. No.: 17/400,137

(22) Filed: Aug. 12, 2021

(30) Foreign Application Priority Data
Jun. 8, 2021 (CN) 202110634764.6

(51) Int. Cl. G06F 16/23; G06F 21/62

(52) U.S. Cl. CPC G06F 16/2379; G06F 21/6209

(57) ABSTRACT

A system for managing a report comprises a generating module, for receiving data of a first user and for generating a first report according to the data; an associating module, coupled to the generating module, for determine a first content of a second report according an association between the first report and the second report; and a notifying module, coupled to the associating module, for notifying a managing result of the first report and the second report to the first user and a second user, wherein the second user is associated with a project corresponding to the first report.

### CROSS REFERENCE TO RELATED APPLICATION

This non-provisional application claims priority of China patent application No. 202110634764.6, filed on 8 Jun. 2021, included herein by reference in its entirety.

### BACKGROUND OF THE INVENTION

### 1. Field of the Invention

The present invention relates to a device and a method utilizing the same, and more particularly, to a system and method of managing a report.

### 2. Description of the Prior Art

A user needs to generate a report on the user's computing device and store the report in a public storage space, when the user intends to store the report in the public storage space. The user needs to repeat the abovementioned operations to store the updated report in the public storage space, when the user intends to update the report to the public storage space. In the situation that the public storage space has no arranging rule or no sorting rule, the user needs to rearrange and sort reports in the public storage space and confirms whether there is any updated report and which report is with the latest version in the public storage space, when the user intends to obtain a report from the public storage space. The user needs to access the public storage space via an internal domain of an enterprise or an internal personnel of the enterprise, when the user intends to access the public storage space from outside the enterprise.

However, the abovementioned operations consume lots of time of the user, which not only makes it difficult for the user to efficiently or timely store the report to the public storage space, but also makes it difficult for the user to efficiently or timely obtain the report from the public storage space. In the situation that the public storage space is not arranged or sorted, the public storage space is difficult to be effectively used. Thus, how to manage report, to enable the user to efficiently access the report and make the public storage space to be effectively used, is an important problem to be solved.

### SUMMARY OF THE INVENTION

The present invention therefore provides a system and method for managing a report to solve the abovementioned problem.

A system for managing a report, comprises a generating module, for receiving data of a first user and for generating a first report according to the data; an associating module, coupled to the generating module, for determining a first content of a second report according to an association between the first report and the second report; and a notifying module, coupled to the associating module, for notifying a management result of the first report and the second report to the first user and a second user, wherein the second user is associated with a project corresponding to the first report.

A method for managing a report, comprises receiving data of a first user and generating a first report according to the data; determining a first content of a second report according to an association between the first report and the second report; and notifying a management result of the first report and the second report to the first user and a second user, wherein the second user is associated with a project corresponding to the first report.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a computing network according to an example of the present invention.

FIG. 2 is a schematic diagram of a system for managing a report according to an example of the present invention.

FIG. 3 is a schematic diagram of a user data transmission interface of a system for managing a report according to an example of the present invention.

FIG. 4 is a schematic diagram of a report list of a system for managing a report according to an example of the present invention.

FIG. 5 is a schematic diagram of a report generated by a system for managing a report according to an example of the present invention.

FIG. 6 is a schematic diagram of a material preparation scheduling of a system for managing a report according to an example of the present invention.

FIG. 7 is a schematic diagram of a scheduling data of a system for managing a report according to an example of the present invention.

FIG. 8 is a flowchart of a process according to an example of the present invention.

### DETAILED DESCRIPTION

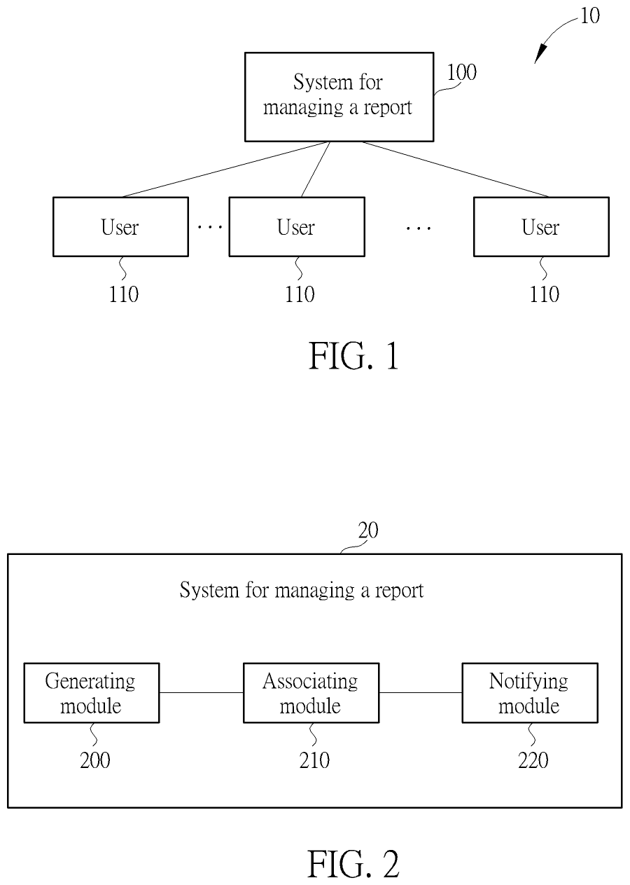

FIG. 1 is a schematic diagram of a computing network 10 according to an example of the present invention. As shown in FIG. 1, the computing network 10 includes a system 100 for managing a report and at least one user 110. In one example, the at least one user 110 may transmit (e.g., store or upload) data to the system 100 for managing a report via a computing device. The system 100 for managing a report may generate a report, and may notify a management result of the report to the at least one user 110 according to data received from the at least one user 110. In one example, the computing device may include devices which are used for connecting to the system 100 for managing a report, such as a desktop computer, a laptop, a tablet, or a mobile phone (such as a smart phone), but is not limited herein.

FIG. 2 is a schematic diagram of a system 20 for managing a report according to an example of the present invention, and may be used in the system 100 for managing a report in FIG. 1. As shown in FIG. 2, the system 20 for managing a report includes a generating module 200, an associating module 210 and a notifying module 220. In detail, the generating module 200 may be for receiving data of a first user (e.g., a first user of the at least one user 110 in FIG. 1) and may be for generating a first report according to the data. The associating module 210 is coupled to the generating module 200, and may be for determining (e.g., generating) a first content of a second report according to an association between the first report and the second report. The notifying module 220 is coupled to the associating module 210, and may be for notifying a management result of the first report and the second report to the first user and a second user (e.g., a second user of the at least one user 110 in FIG. 1). The second user may be associated with a project corresponding to the first report (e.g., to which the first report belongs).

In one example, the first user may include an internal personnel of an enterprise or a vendor. In one example, the second user may include an (e.g., another) internal personnel of the enterprise, a (e.g., another) vendor, or a customer. In one example, the (e.g., another) internal personnel of the enterprise may include a mechanical (ME) personnel (e.g., ME engineer), an industrial designer (ID) personnel (e.g., ID engineer), a process (PES) personnel (e.g., PES engineer), a printed circuit board (PCB) personnel (e.g., PCB engineer), a testing personnel (e.g., testing engineer), a product line assembler or a project/product administrator (e.g., project manager). In one example, the vendor may include a supplier.

In one example, the generating module 200 may generate a code of the first report according to (e.g., by using) an encoding information. In one example, the encoding information may include at least one information of the following information: a time (e.g., date) or a version. In one example, the encoding information may include a type of the first report. In one example, the first report may be arranged (e.g., classified, archived, or sorted) according to (e.g., by using) the code of the first report.

In one example, the data may include at least one information of the following information: a figure (e.g., image or photo) or a text description. In one example, the figure may include two-dimensional figure or three-dimensional figure. In one example, the text description may include the number of parts. That is, the generation module 200 may generate the first report in a specific format by enabling the first user to transmit the data with specific formats.

In one example, the association may include (e.g., be) that the first report and the second report are corresponding to (e.g., belong to) the project. In one example, the project may be realized according to (e.g., by using) a folder. That is, in the system 20 for managing a report, a folder may be corresponding to a project.

In one example, a field corresponding to the first content may be included in the first report. That is, the first report and the second report include the same field. In one example, the associating module 210 may determine (e.g., generate) the first content according to a second content corresponding to the field in the first report. That is, the associating module 210 may automatically substitute the second content into the first content, i.e., replace the first content with the second content. For example, the first report includes specific fields (e.g., “FAI C2” and “specification standard”), which are corresponding to the second content (e.g., −4.100). The associating module 210 may automatically substitute the second content into the first content corresponding to the specific fields in the second report, i.e., the first content is −4.100, when the associating module 210 determines (e.g., detects) that the second report and the first report belong to the same project and the second report also includes the specific fields. It should be noted that, the abovementioned example is an example of the present invention, but is not limited herein.

In one example, the notifying module 220 may notify the management result to the first user and the second user via a communication software or a bulletin board of a login screen of the system 20 for managing a report. In one example, the notifying module 220 may notify a confirmation reply (e.g., button) of the management result to the first user and the second user via the communication software or the bulletin board of the login screen of the system 20 for managing a report. The first user and the second user may notify that the management result is confirmed to the system 20 for managing a report via confirming (e.g., clicking or pressing) the confirmation reply. In one example, the communication software may include an E-mail software (e.g., Outlook or Gmail), but is not limited herein.

In one example, the management result may include at least one information of the following information: a first update information of the first report, a second update information of the second report, a third update information of the data, a progress of the project, or a pending item of the project.

In one example, the notifying module 220 may notify the third update information associated with an update to the first user and the second user via the management result, when the generating module 200 determines that the data includes the update. In one example, the generating module 200 may determine that the data includes the update according to a change of the data. For example, the generating module 200 determines that the data includes the update according to the change of the data (e.g., change(s) in station(s), change(s) in process step(s), change(s) in tolerance analysis method(s), or change(s) in measurement rule(s)) transmitted by the first user. The notifying module 220 may notify the third update information associated with the update to the first user and the second user via the bulletin board of the login screen of the system 20 for managing a report.

In one example, the generating module 200 may determine (e.g., analyze) whether the data is incomplete (e.g., incomplete assembly of parts) according to a comparison of data with previously transmitted data, when the generating module 200 determines that the data (e.g., the figure of the assembled parts and the number of parts) includes the update. The generating module 200 may generate debugging information and notify the third update information associated with an update and the debugging information to the first user and the second user via the management result, when the generating module 200 determines that the data is incomplete. In one example, the comparison of the data with previously transmitted data may include a comparison of two-dimensional figures, three-dimensional figures and a comparison of the number of parts. In one example, the first user may modify the data to debug according to the debugging information. In one example, the first user may send modified data to the system 20 for managing a report, and the generating module 200 may repeatedly perform the above operations. In one example, the first user may repeatedly send modified data to the system 20 for managing a report, until the first user does not receive the debugging information.

In one example, the first user is configured with a login method and an access permission by an administrator of the project. In one example, the access permission of the first user may be configured to be able to store data or obtain reports. In one example, an access permission of the second user may be configured to be able to store data or obtain reports, when the second user is an internal personnel of the enterprise. In one example, the access permission of the second user may be configured to be able to store data or obtain reports, when the second user is a vendor. In one example, the access permission of the second user may be configured to be able to obtain reports, when the second user is a client.

In one example, the administrator of the project may dynamically adjust (e.g., add or remove) a user of the project and may configure a login method and an access permission for the user of the project according to the needs of the project, before creating the project. In one example, the administrator of the project may add the first user and the second user of the project, and may configure login methods and access permissions for the first user and the second user of the project. In one example, the administrator of the project may dynamically adjust (e.g., add or remove) a user of the project and may configure a login method and an access permission for the user of the project according to the needs of the project, during creating the project. In one example, the administrator of the project may dynamically remove the first user and the second user of the project, and may reconfigure (e.g., modify) the login methods and the access permissions for the first user and the second user. In one example, the administrator of the project may add a third user of the project and may configure a login method and an access permission for the third user.

In one example, the system 20 for managing a report does not display (e.g., list) information associated with the project (e.g. report list or report), when a fourth user is not configured with an access permission logins in the system 20 for managing a report. That is, the fourth user who is not configured with the access permission cannot access (e.g., view) information of the project. In one example, reports of the project (e.g., the first report or the second report) may be configured with an anti-copy mechanism by the administrator of the project.

In one example, the generating module 200 may be for receiving a request of the second user, wherein the request may include searching for the first report. The generation module 200 may display all reports related to the first report (e.g., all versions of the first report) according to the request. The second user may obtain the latest version or any version of the first report. In one example, the notifying module 220 may notify the first update information of the first report to the second user, when the generating module 200 receives the data of the first user and generates an updated version of the first report. The second user may obtain the updated version of the first report via logging in the system 20 for managing a report.

In one example, the system 20 for managing a report may integrate (e.g., connect to) a system for managing a product (e.g., product data management system (PDM)). The first user, the second user or the third user may obtain (e.g., retrieve) information of the system for managing a product, and may use functions of the system for managing a product (e.g., query figures of the product or obtain information of the product) via the system 20 for managing a report.

In one example, the system 20 for managing a report may integrate (e.g., connect to) a system for managing a part (e.g., Integrate ME and layout database system (MCL)). The first user, the second user or the third user may obtain (e.g., retrieve) information of the system for managing a part, and may use functions of the system for managing a part (e.g., query figures of the part, obtain information of the part or apply for a new part) via the system 20 for managing a report.

In one example, the system 20 for managing a report may integrate (e.g., connect to) a system for managing an attendance. The first user, the second user or the third user may obtain (e.g., retrieve) information of the system for managing an attendance, and may use functions of the system for managing an attendance (e.g., query a staff's basic information (e.g., communication method, affiliated unit or title), submit a business trip application, respond to (e.g., approval or disapproval) the business trip application, submit leave application or respond to (e.g., approval or disapproval) the leave application) via the system 20 for managing a report.

In one example, the system 20 for managing a report may integrate (e.g., connect to) a system for reading a product's barcode. The first user, the second user or the third user may obtain (e.g., retrieve) information of the system for reading a product's barcode, and may use functions of the system for reading a product's barcode (e.g., reading the product's barcode). In one example, the first user, the second user or the third user may generate (e.g., predict) an assembly result of a product according to the information of the system for reading a product's barcode.

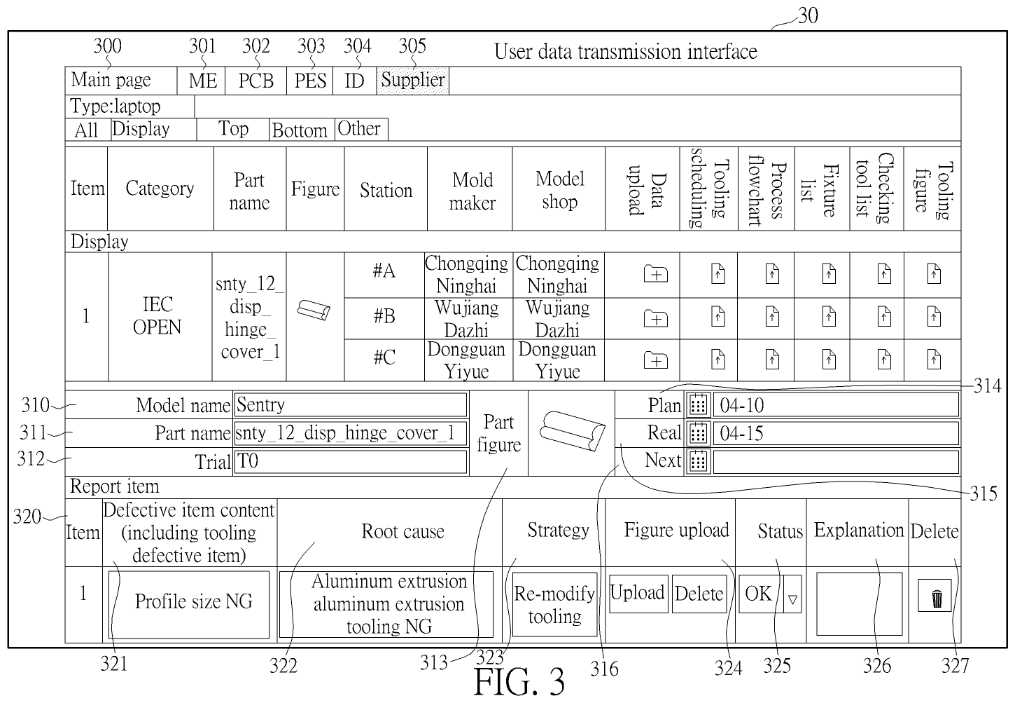

FIG. 3 is a schematic diagram of a user data transmission interface 30 of the system 20 for managing a report according to an example of the present invention. The user data transmission interface 30 may be for a user to input data, to receive the user's data. As shown in FIG. 3, the user data transmission interface 30 may include a main page field 300, a ME field 301, a PCB field 302, a PES field 303, an ID field 304 or a supplier field 305. The main page field 300 may be for the user to go (e.g., return) to a main page. The ME field 301 may be for the user to input data on a page for a ME personnel. The PCB field 302 may be for the user to input data on a page for a PCB personnel. The PES field 303 may be for the user to input data on a page for a PES personnel. The ID field 304 may be for the user to input data on a page for an ID personnel. The supplier field 305 may be for the user to input data on a page for a supplier. As shown in FIG. 3, the supplier field 305 is illustrated with dotted pattern, which refers to that the current page is the page for the supplier, i.e., the user goes to the page for the supplier and inputs data.

As shown in FIG. 3, the user data transmission interface 30 may include a model name field 310, a part name field 311, a trial field 312, a part figure field 313, a plan field 314, a real field 315 or a next field 316. The model name field 310 may be for the user to input a model name, e.g., “Sentry”, but is not limited herein. The part name field 311 may be for the user to input a part name, e.g., “snty_12_disp_hinge_cover_1”, but is not limited herein. The trial field 312 may be for the user to input a trial duration, e.g., “T0”, but is not limited herein. The part figure field 313 may be for displaying a figure uploaded by the user, e.g., the figure as shown in FIG. 3, but is not limited herein. The plan field 314 may be for the user to input (e.g., select) a plan execution time, e.g., “04-10”, but is not limited herein. The real field 315 may be for the user to input (e.g., select) areal execution time, e.g., “04-15”, but is not limited herein. The next field 316 may be for the user to input (e.g., select) a next execution time, e.g., not input by the user as shown in FIG. 3, but is not limited herein.

As shown in FIG. 3, the user data transmission interface 30 may include a report item. The report item may include an item field 320, a defective item content (including tooling (e.g., mold) defective item) field 321, a root cause field 322, a strategy field 323, a figure upload field 324, a status field 325, an explanation field 326 or a delete field 327. The item field 320 may be for displaying (e.g., listing) a defective item input by the user. The defective item content (including tooling defective item) field 321 may be for the user to input content associated with the defective item, e.g., “profile size NG”, but is not limited herein. The root cause field 322 may be for the user to input a root cause of causing the defective item, e.g., “Aluminum extrusion Aluminum extrusion tooling NG”, but is not limited herein. The strategy field 323 may be for the user to input a strategy for solving the defective item, e.g., “Re-modify tooling”, but is not limited herein. The figure upload field 324 may be for the user to select a part figure (e.g., display as the part FIG. 313) to upload or delete the part FIG. 313. The status field 325 may be for the user to input (e.g., select) a status of the defective item, e.g., “OK”, but is not limited herein. The explanation field 326 may be for the user to input other notice associated with the defective item. The delete field 327 may be for the user to delete the defective item corresponding to the delete field 327, e.g., the defective item corresponding to the item “1”. That is, the system 20 for managing a report may receive the user's data and may generate the report accordingly via the abovementioned data input by the user or the abovementioned figure uploaded by the user.

It should be noted that, the abovementioned description of FIG. 3 only states contents related to the present invention. The user data transmission interface 30 may include other fields, buttons and/or tools related to the report, e.g., a type field, an all field, a display field, a top field, a bottom field, an other field, a category item, a station field, a mold maker field, a model shop field, a data upload field, a tooling scheduling field, a process flowchart field, a fixture list field, a checking tool list field or a tooling figure field as shown in FIG. 3, but is not limited herein.

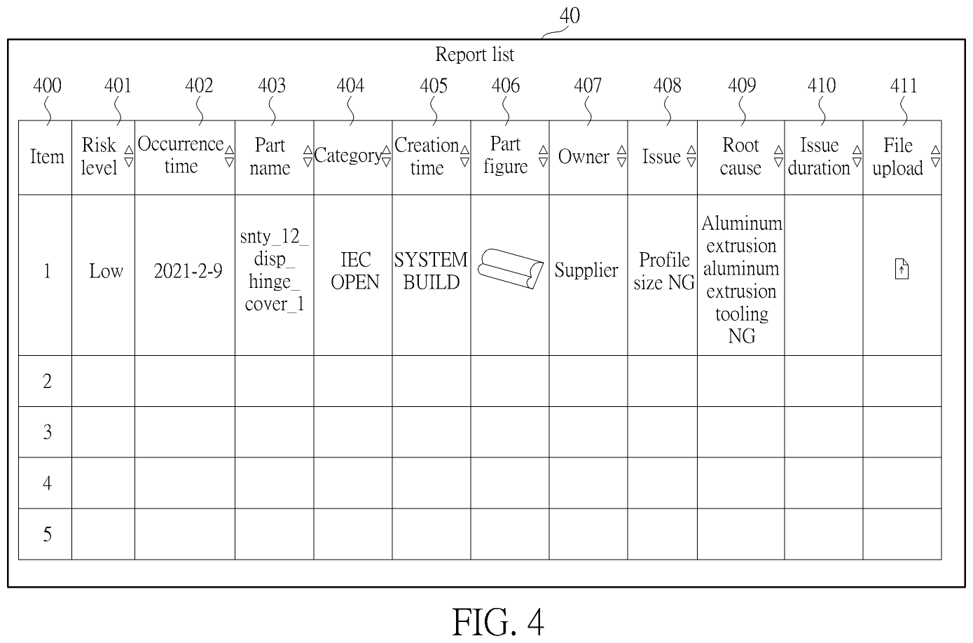

FIG. 4 is a schematic diagram of a report list 40 of the system 20 for managing a report according to an example of the present invention. The report list 40 may be for displaying a list of generated reports. As shown in FIG. 4, the report list 40 may include an item field 400, a risk level field 401, an occurrence time field 402, a part name field 403, a category field 404, a creation time field 405, a part figure field 406, an owner field 407, an issue field 408, a root cause field 409, an issue duration field 410 or a file upload field 411.

As shown in FIG. 4, the item field 400 may be for displaying (e.g., listing) generated reports. The risk level field 401 may be for displaying a risk level of the report, e.g., according to a text “high”, “medium” or “low”, or according to a color from dark to light to represent the risk level from high to low, but is not limited herein. The occurrence time field 402 may be for displaying an occurrence time of the report, e.g., “2021-2-9”, but is not limited herein. The part name field 403 may be for displaying a part name in the report, e.g., “snty_12_disp_hinge_cover_1”, but is not limited herein. The category field 404 may be for displaying a category field in the report, e.g., “IEC OPEN”, but is not limited herein. The creation time field 405 may be for displaying a creation time of the report, e.g., “SYSTEM BUILD”, but is not limited herein. The part figure field 406 may be for displaying a part figure in the report, e.g., as the part FIG. 313 illustrated in FIG. 3, but is not limited herein. The owner field 407 may be for displaying an owner of the report, e.g., “supplier”, but is not limited herein. The issue field 408 may be for displaying a defective item content (including tooling defective item) in the report, e.g., “profile size NG”, but is not limited herein. The root cause field 409 may be for displaying a root cause in the report, e.g., “Aluminum extrusion Aluminum extrusion tooling NG”, but is not limited herein. The issue duration field 410 may be for displaying a duration of the defective item content (including a tooling defective item) in the report. The file upload field 411 may be for the user to upload data or files associated with the report, but is not limited herein.

It should be noted that, the abovementioned description of FIG. 4 only states contents related to the present invention. The report list 40 may include other fields, buttons and/or tools related to the report, but is not limited herein.

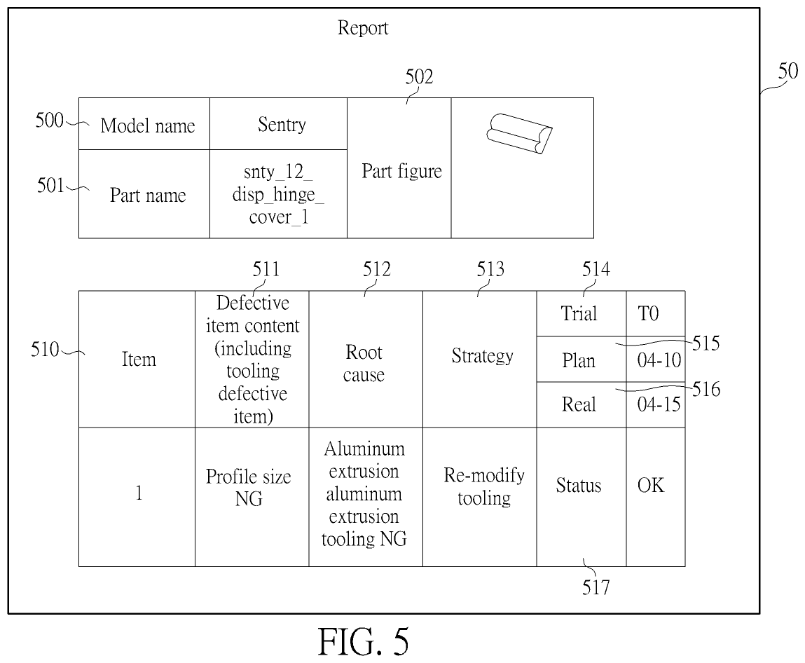

FIG. 5 is a schematic diagram of a report 50 generated by the system 20 for managing a report according to an example of the present invention. As shown in FIG. 5, the report 50 may include a model name field 500, a part name field 501, a part figure field 502, an item field 510, a defective item content (including tooling defective item) field 511, a root cause field 512, a strategy field 513, a trial field 514, a plan field 515, a real field 516 or a status field 517.

As shown in FIG. 5, the model name field 500 may be for displaying a model name input by the user, e.g., “Sentry”, but is not limited herein. The part name field 501 may be for displaying a part name input by the user, e.g., “snty_12_disp_hinge_cover_1”, but is not limited herein. The part figure field 502 may be for displaying a figure uploaded by the user, e.g., as the part FIG. 313 illustrated in FIG. 3, but is not limited herein. The item field 510 may be for displaying (e.g., listing) a defective item input by the user. The defective item content (including tooling defective item) field 511 may be for displaying content associated with the defective item input by the user, e.g., “profile size NG”, but is not limited herein. The root cause field 512 may be for displaying a root cause of causing the defective item input by the user, e.g., “Aluminum extrusion Aluminum extrusion tooling NG”, but is not limited herein. The strategy field 513 may be for displaying a strategy for solving the defective item input by the user, e.g., “Re-modify tooling”, but is not limited herein. The trial field 514 may be for displaying a trial duration input by the user, e.g., “T0”, but is not limited herein. The plan field 515 may be for displaying a plan execution time input by the user, e.g., “04-10”, but is not limited herein. The real field 516 may be for displaying a real execution time input by the user, e.g., “04-15”, but is not limited herein. The status field 517 may be for displaying a status of the defective item input by the user, e.g., “OK”, but is not limited herein.

It should be noted that, the abovementioned description of FIG. 5 only states contents related to the present invention. The report 50 may include other fields, buttons and/or tools related to the report, but is not limited herein.

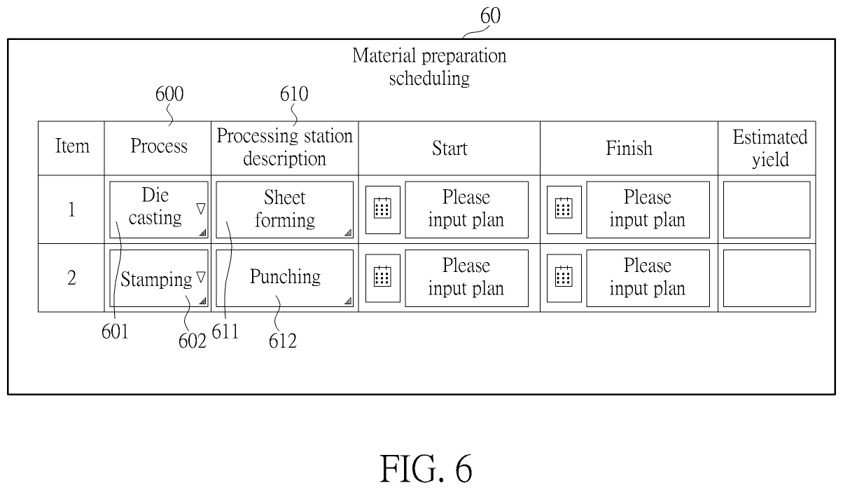

FIG. 6 is a schematic diagram of a material preparation scheduling 60 of the system 20 for managing a report according to an example of the present invention. The material preparation scheduling 60 may be a user data transmission interface for a user to input data, to receive the user's data. As shown in FIG. 6, the material preparation scheduling 60 may include a process field 600 or a processing station description field 610. The process field 600 may be for the user to input a process, e.g., “die casting” 601 corresponding to the item “1” or “stamping” 602 corresponding to the item “2”, but is not limited herein. The processing station description field 610 may be for the user to input a processing station description, e.g., “sheet forming” 611 corresponding to the item “1” or “punching” 612 corresponding to the item “2”, but is not limited herein.

It should be noted that, the abovementioned description of FIG. 6 only states contents related to the present invention. The material preparation scheduling 60 may include other fields, buttons and/or tools related to the material preparation or the scheduling, e.g., an item field, a start field, a finish field or an estimated yield field, but is not limited herein.

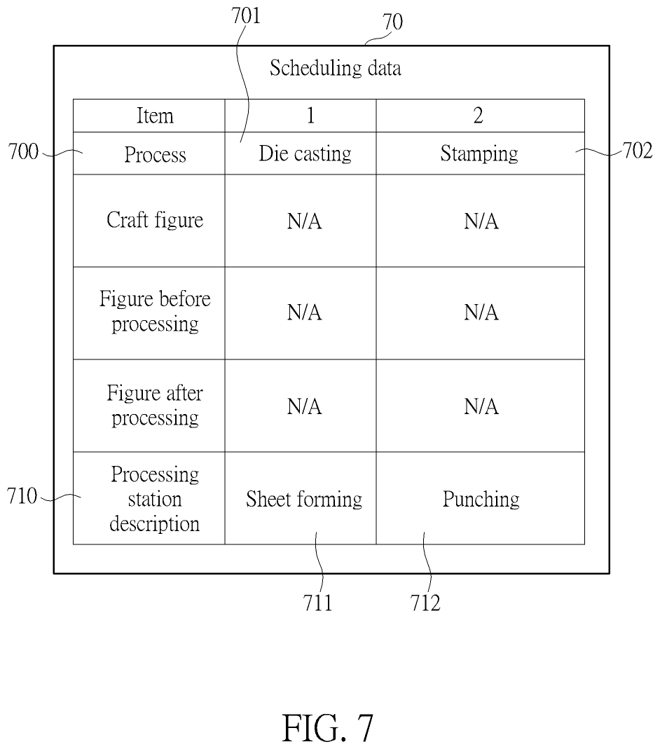

FIG. 7 is a schematic diagram of a scheduling data 70 of the system 20 for managing a report according to an example of the present invention. The scheduling data 70 may be associated with the material preparation scheduling 60 in FIG. 6, e.g., the material preparation scheduling 60 and the scheduling data 70 may belong to the same project. As shown in FIG. 7, the scheduling data 70 may include a process field 700 and a processing station description field 710. The associating module 210 may determine (e.g., generate or automatically substitute) content corresponding to the process field 700 is “die casting” 701 according to content “die casting” 601 corresponding to the process field 600 in the material preparation scheduling 60. The associating module 210 may determine (e.g., generate or automatically substitute) content corresponding to the processing station description field 710 is “sheet forming” 711 according to content “sheet forming” 611 corresponding to the processing station description field 610 in the material preparation scheduling 60. The associating module 210 may determine (e.g., generate or automatically substitute) content corresponding to the process field 700 is “stamping” 702 according to content “stamping” 602 corresponding to the process field 600 in the material preparation scheduling 60. The associating module 210 may determine (e.g., generate or automatically substitute) content corresponding to the processing station description field 710 is “punching” 712 according to content “punching” 612 corresponding to the processing station description field 610 in the material preparation scheduling 60.

It should be noted that, the abovementioned description of FIG. 7 only states contents related to the present invention. The scheduling data 70 may include other fields, buttons and/or tools related to the material preparation or the scheduling, e.g., an item field, a craft figure field, a figure before processing field or a figure after processing field, but is not limited herein.

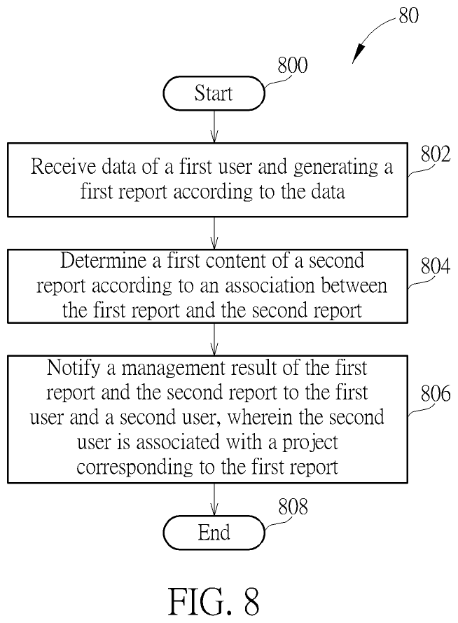

Operations of the system 20 for managing a report in the above examples can be summarized into a process 80 shown in FIG. 8. The process 80 includes the following steps:

Step 800: Start.

Step 802: Receive data of a first user and generating a first report according to the data.

Step 804: Determine a first content of a second report according to an association between the first report and the second report.

Step 806: Notify a management result of the first report and the second report to the first user and a second user, wherein the second user is associated with a project corresponding to the first report.

Step 808: End.

It should be noted that, the abovementioned “first”, “second”, “third” and “fourth” are used for distinguishing related statements, and are not used for limiting an order of related statements. The abovementioned “store” may be replaced by “upload”. The abovementioned “obtain” may be replaced by “download”.

It should be noted that, realizations of the system 20 for managing a report (and the generating module 200, the associating module 210 and/or the notifying module 220 therein) are various. For example, the abovementioned modules may be integrated into one or more modules. In addition, the system 20 for managing a report (and the generating module 200, the associating module 210 and/or the notifying module 220 therein) may be realized by hardware (e.g., circuit or chip), software (e.g., code), firmware (known as a combination of a hardware device, computer instructions and data that reside as read-only software on the hardware device), an electronic system or a combination of the devices mentioned above, and is not limited herein. The abovementioned description, steps and/or processes may be realized by hardware (e.g., circuit or chip), software (e.g., code), firmware (known as a combination of a hardware device, computer instructions and data that reside as read-only software on the hardware device), an electronic system or a combination of the devices mentioned above, and is not limited herein.

To sum up, the present invention provides a system and related method for managing a report. A user transmits data to the system for managing a report and the system may automatically generate the report and a code of the report according to the data, when the user intends to store the report in the public storage space. According to the code, the user may confirm whether there is any updated report and which report is with the latest version, when the user intends to obtain a report from the public storage space. The user may access a report via logging in the system for managing a report, when the user intends to access the public storage space from outside the enterprise. That is, the user may efficiently or timely store the report and the public storage space is effectively used. Thus, the problem in the prior art is solved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A system for managing a report, comprising:
a generating module, for receiving data of a first user and for generating a first report according to the data;
an associating module, coupled to the generating module, for determining a first content of a second report according to an association between the first report and the second report; and
a notifying module, coupled to the associating module, for notifying a management result of the first report and the second report to the first user and a second user, wherein the second user is associated with a project corresponding to the first report.

2. The system of claim 1, wherein the generating module generates a code of the first report according to an encoding information, wherein the encoding information comprises at least one information of the following information: a time or a version.

3. The system of claim 1, wherein the data comprises at least one information of the following information: a figure or a text description.

4. The system of claim 1, wherein the association comprises that the first report and the second report are corresponding to the project.

5. The system of claim 1, wherein a field corresponding to the first content is comprised in the first report, wherein the associating module determines the first content according to a second content corresponding to the field in the first report.

6. The system of claim 1, wherein the notifying module notifies the management result to the first user and the second user via a communication software.

7. The system of claim 1, wherein the management result comprises at least one information of the following information: a first update information of the first report, a second update information of the second report, a third update information of the data, a progress of the project, or a pending item of the project.

8. The system of claim 7, wherein the notifying module notifies the third update information associated with an update to the first user and the second user via the management result, when the generating module determines that the data comprises the update.

9. The system of claim 1, wherein the first user is configured with a login method and an access permission by an administrator of the project.

10. A method for managing a report, comprising:
receiving data of a first user and generating a first report according to the data;
determining a first content of a second report according to an association between the first report and the second report; and
notifying a management result of the first report and the second report to the first user and a second user, wherein the second user is associated with a project corresponding to the first report.

11. The method of claim 10, further comprising:
generating a code of the first report according to an encoding information, wherein the encoding information comprises at least one information of the following information: a time or a version.

12. The method of claim 10, wherein the data comprises at least one information of the following information: a figure or a text description.

13. The method of claim 10, wherein the association comprises that the first report and the second report are corresponding to the project.

14. The method of claim 10, wherein a field corresponding to the first content is comprised in the first report, and the method further comprising:
determining the first content according to a second content corresponding to the field in the first report.

15. The method of claim 10, further comprising:
notifying the management result to the first user and the second user via a communication software.

16. The method of claim 10, wherein the management result comprises at least one information of the following information: a first update information of the first report, a second update information of the second report, a third update information of the data, a progress of the project, or a pending item of the project.

17. The method of claim 16, further comprising:
notifying the third update information associated with an update to the first user and the second user via the management result, when determining that the data comprises the update.

18. The method of claim 10, wherein the first user is configured with a login method and an access permission by an administrator of the project.
